(19) United States
(12) Patent Application Publication
(10) Pub. No.: US 2015/0241329 A1
(43) Pub. Date: Aug. 27, 2015

(54) METHOD OF ASSESSING DUST CONTROLS IN MINING

(71) Applicant: Brian William Plush, Ourimbah (AU)

(72) Inventor: Brian William Plush, Ourimbah (AU)

(21) Appl. No.: 14/373,910

(22) PCT Filed: Feb. 9, 2012
(86) PCT No.: PCT/AU2012/000113

§ 371 Date: Jul. 23, 2014

(51) Int. Cl. G01N 15/06; E21F 5/00; G05B 15/02

(52) U.S. Cl. CPC G01N 15/06; G05B 15/02; E21F 5/00; G01N 2015/0096

(57) ABSTRACT

A method of assessing the effectiveness of a dust control in reducing dust at one or more locations (201-213) in a mine, the method comprising the steps of: installing (301) a dust meter each location (201-213); mining ore for a control-deactivated period with the dust control deactivated (302); determining a control-deactivated dust level having regard to an amount of dust measured at one or more of the dust meters during the control-deactivated period (303); mining ore for a control-activated period with the dust control activated (304); determining a control-activated dust level having regard to an amount of dust measured at the one or more of the dust meters during the control-activated period (305); and comparing the control-activated dust level with the control-deactivated dust level (306).

### FIELD

The present invention relates to dust control in mining, particularly but not limited to dust control in underground longwall coal mining.

### BACKGROUND

Occupational hygiene has been an integral part of the mining industry for centuries; however its importance has grown with developments in mechanisation.

The current statutory testing regime identifies the exposure levels of personnel on an operating face over the duration of a mining shift, which gives a snapshot of the dust that these persons will be exposed to. Although this testing process clearly determines cumulative exposure levels, it does not give mine operators any indication of where dust is produced, how much dust is produced nor how efficient the installed controls are at mitigating produced dust. Further, production of dust can vary significantly depending on mining conditions.

There is therefore a need to provide an improved method of assessing the effectiveness of dust controls.

### SUMMARY OF THE INVENTION

According to a broad aspect of the invention there is provided a method of assessing the effectiveness of a dust control in reducing dust at one or more locations in a mine, the method comprising the steps of:

installing a dust meter each location;

mining ore for a control-deactivated period with the dust control deactivated;

determining a control-deactivated dust level having regard to an amount of dust measured at one or more of the dust meters during the control-deactivated period;

mining ore for a control-activated period with the dust control activated;

determining a control-activated dust level having regard to an amount of dust measured at the one or more of the dust meters during the control-activated period; and

comparing the control-activated dust level with the control-deactivated dust level.

In one embodiment, the method further comprises the steps of:

measuring an amount of ore mined during the control-deactivated period; and

measuring an amount of ore mined during the control-activated period;

wherein the step of determining the control-deactivated and control-activated dust levels has regard to the respective measured amounts of ore mined.

In another embodiment, the control-activated period is terminated when a certain amount of ore has been mined since a commencement of the control-activated period, and the control-deactivated period is terminated when the same or similar certain amount of ore has been mined since a commencement of the control-deactivated period.

In one embodiment, the control-activated period covers a certain fraction or number of mining cycles, and the control-deactivated period covers the same certain fraction or number of mining cycles.

In one embodiment, the determined dust levels are equivalent to or functions of the amounts of dust measured per the amounts of ore mined in the respective periods.

In one embodiment, the step of comparing comprises computing and reporting a dust control efficiency as an absolute or percentage amount by which the control-activated dust level was changed compared to control-deactivated dust level.

In one embodiment, the mine is a coal mine and the ore is coal. The coal mine may be an underground longwall coal mine. The dust may be respirable or inhalable dust.

In one embodiment, the control-activated and control-deactivated periods are substantially shorter than an entire shift, and may cover one or several mining cycles.

The term “a dust control” in the claims includes a single dust control device such as a spray unit, or a group of individual dust control devices considered together.

### BRIEF DESCRIPTION OF DRAWINGS

FIG. 1 is a functional diagram of a longwall coal mine;

FIG. 2 is a perspective view of a longwall and associated equipment;

FIG. 3 is a diagram of a longwall mine with dust collection locations in one embodiment;

FIG. 4 is a block diagram of the method steps of this embodiment of the invention.

### DETAILED DESCRIPTION OF EMBODIMENTS

An embodiment of the current invention will now be described.

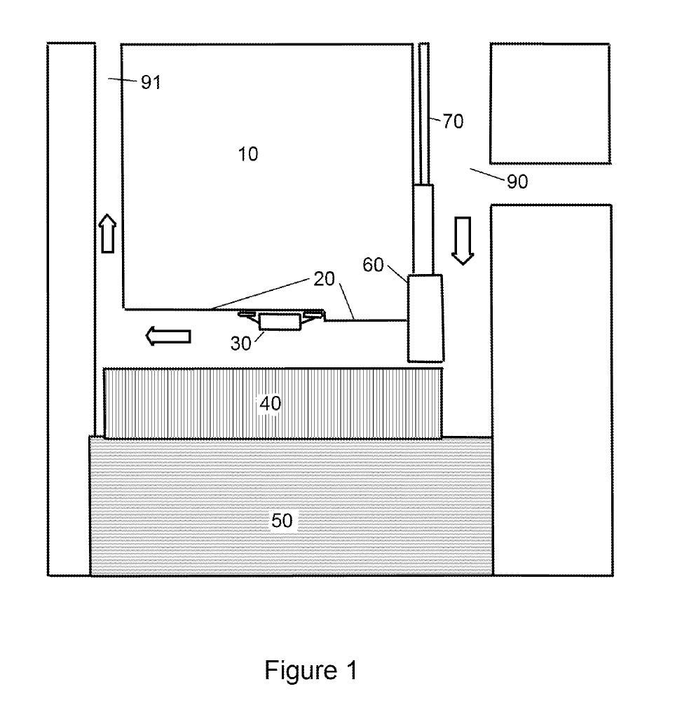

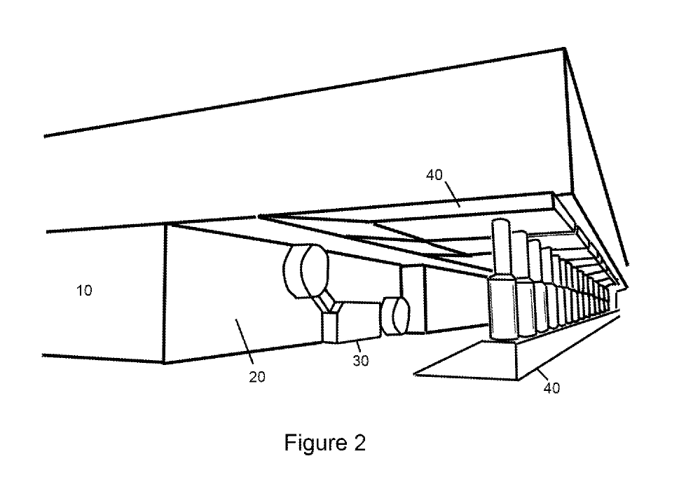

Referring first to FIGS. 1 and 2, an embodiment of the invention will be described as applied to a longwall coal mine.

The coal mine comprises a coal mine face called a longwall 20 advancing into a coal seam 10 between maingate road 90 and tailgate road 91. Shearer 30 cuts coal from the longwall 20 which is conveyed to a stageloader/crusher 60, and crushed coal exits the mine along a conveyor belt 70 on the maingate road 90. Ventilation air is forced from outside down maingate road 90, and passes along the longwall 20 and exits as stale air the mine along tailgate road 91. Protecting the workers along the longwall from collapsing overburden is an advancing roof comprising hydraulic chocks 40. The chocks 40 are stepped forward as the longwall advances, leaving behind an unsupported cavity under the overburden which soon collapses as “goaf” 50.

Longwall personnel can be exposed to harmful dust from multiple dust generation sources including the operation of the shearer 30, intake entry along the maingate road 90, belt 70 entry, stageloader/crusher 60, advance of the chocks 40 and dust ingress from falling goaf 50 or over-pressurisation of the goaf 50, longwall face spalling ahead of the shearer 30.

Dust control strategies in place for the mitigation of dust are well known and vary from mine to mine, with each individual mine having a dust mitigation setup that is only effective for that particular mine operation. For example, typical individual dust controls include various spray devices which spray water at a point of dust generation.

The industry in Australia has been using statutory dust measurements in underground coal mines conducted by both SIMTARS and Coal Services that rely on Australian Standards AS 2985 for respirable size dust particles, and AS 3640 for inhalable size dust particles. The majority of dust sampling to date has been with cyclone separation and collection of the sized particles for weighing, in the prior art generally over the period of a full shift.

In this embodiment, the dust meters are of the conventional type, operating as specified in the Australian standards. AS2985 and AS3640 clearly define the process used to determine personal exposure levels in coal mines. The same equipment is used in this embodiment to collect dust load at each individual source of dust generation on a longwall to ensure uniformity of collected data, reliability of data analysis and approved for use in underground coal mines.

Section 6.1 of AS2985—“Workplace atmospheres—method for sampling and gravimetric determination of respirable dust” states the essential features of a sampling system consisting of a filter (on which the sample is collected) and a pump for drawing the air through the filter. The filter shall be secured in a holder that prevents air from leaking around the edge of the filter. The filter is preceded by a size-selective sampler.

According to Section 6.1 of AS3640—“Workplace atmospheres—method for sampling and gravimetric determination of inhalable dust” the essential features of a sampling system are an inhalable dust sampling device (containing a filter on which the sample is collected) and a pump for drawing the air through the device. The filter is secured in the device in such a manner that it prevents air from leaking around the edge of the filter.

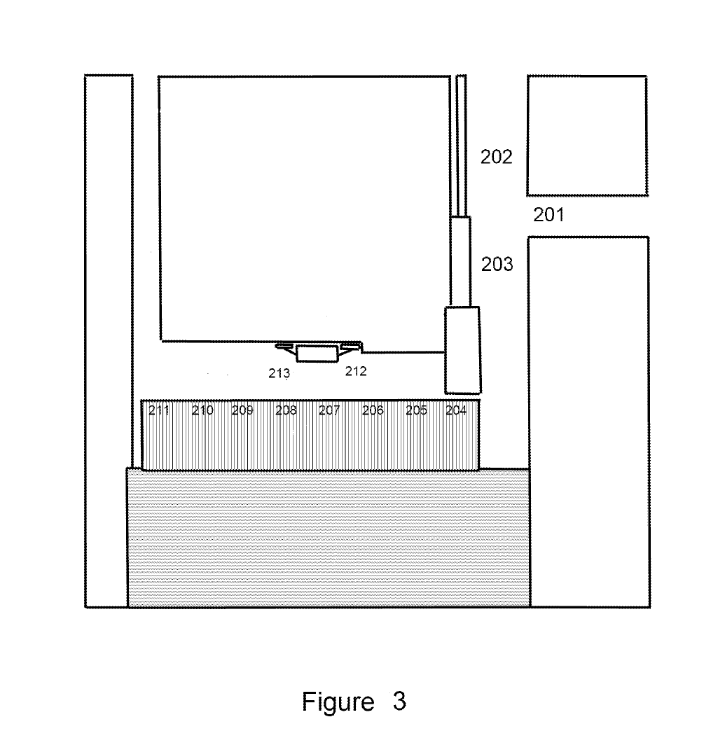

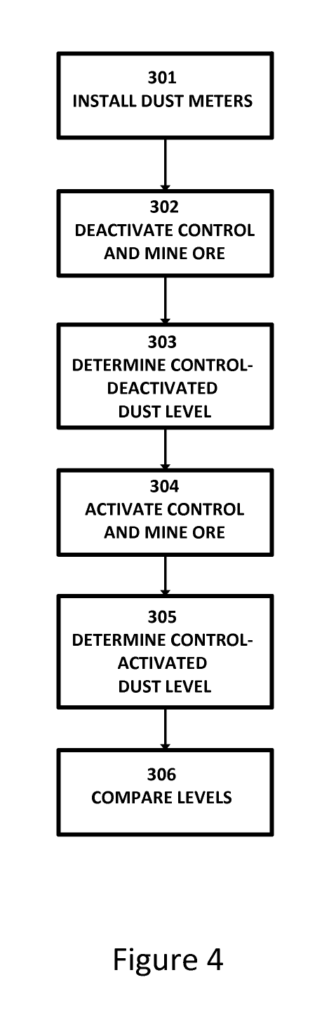

Referring now to FIGS. 3 and 4, locations in this embodiment for installation of the dust meters in step 301 of the method of the invention are at the Last Open Cut-through 201 Belt road 202, Beam Stage Loader 203, spaced points along the chocks 204-210, the tailgate shield 211, the maingate shearer operator 212 and the tailgate shearer operator 213, at the locations indicated by the numerals. Separate monitors and heads may be used for separately measuring inhalable and respirable dust.

In step 302 of the method, ore (coal) is mined for a control-deactivated period with a dust control of the mine deactivated. The dust control of interest may be a single one of the individual controls, or a combination of individual controls deactivated together. In practice there will be safety constraints on removing all of the individual controls, for example turning off all the individual controls on the shearer at once may be inadvisable for safety reasons. The control-deactivated period is conveniently a single mining cycle: in the case of a mine where the shearer operates only in one direction, the mining cycle commences when the shearer starts cutting at one end of the longwall and terminates at the other end; and in the case of a mine where the shearer operates in both directions, the mining cycle terminates when the shearer has returned to its starting point. Typically there are many mining cycles in a shift, so the period is substantially shorter than a shift.

Advantageously, a weighbridge on the conveyor belt or elsewhere can be logged or monitored to measure an amount of ore (coal) that has been mined during the control-deactivated period.

In step 303 of the method, a control-deactivated dust level is determined having regard to an amount of dust measured at one or more of the dust meters during the control-deactivated period. In this embodiment, the level is determined also having regard to the amount of ore that has been mined during the control-deactivated period. Specifically, the amount of dust (expressed in mg) is divided by the amount of ore mined (measured in tonnes) to determine the dust level (expressed in mg/tonne). As the amount of dust produced is typically proportional to the amount of ore mined, this is a more representative figure for comparison.

In step 304 of the method, the dust control is re-activated, and ore is mined for a control-activated period, the respirable and inhalable heads of the dust meters of course having been changed. Preferably, this step 304 is performed closely or immediately after the de-activation step so as to take advantage of similar mining conditions. In this embodiment, the same number of mining cycles are used to define the control-activated period as the control-deactivated period, and the weighbridge is used again to measure the amount of ore (coal) mined during the control-deactivated period.

In step 305 of the method, a control-activated dust level is determined having regard to an amount of dust measured at one or more of the dust meters during the control-activated period. In this embodiment, the level is determined also having, regard to the amount of ore that has been mined during the control-activated period. As in step 303, in this embodiment the amount of dust is divided by the amount of ore mined to determine the dust level (in mg/tonne).

In step 306 of the method, the control-activated dust level is compared with the control-deactivated dust level. In this embodiment, the comparison is performed by computing and reporting a dust control efficiency as an absolute or percentage amount by which the control-activated dust level was changed (hopefully reduced) compared to control-deactivated dust level.

By methodically comparing dust levels produced without and with the dust control, the method of the invention enables improved assessment of the effectiveness of the dust control, and thereby facilitates the design and testing of improved controls to further lower the exposure of dangerous dust to mine workers.

Persons skilled in the art will also appreciate that many variations may be made to the invention without departing from the scope of the invention.

For example, while in the embodiment described the periods are single mine cycles and the levels are normalized according to the amount mined in each period, in other embodiments the periods can be terminated in each case when a certain amount of ore has been mined, as measured at the weighbridge. In this case, the actual amounts of dust in each period will be able to be compared reliably without division by the amount mined in each respective period. Further, while the embodiment described is an application to a coal mine, the invention extends to all forms of mining.

The method steps as set forth in the invention are not to be interpreted as necessarily performed serially or in the particular sequence recited.

In the claims which follow and in the preceding description of the invention, except where the context-requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A method of assessing the effectiveness of a dust control in reducing dust at one or more locations in a mine, the method comprising the steps of:
installing a dust meter each location;
mining ore for a control-deactivated period with the dust control deactivated;
determining a control-deactivated dust level having regard to an amount of dust measured at one or more of the dust meters during the control-deactivated period;
mining ore for a control-activated period with the dust control activated;
determining a control-activated dust level having regard to an amount of dust measured at the one or more of the dust meters during the control-activated period; and
comparing the control-activated dust level with the control-deactivated dust level.

2. A method as claimed in claim 1, further comprising the steps of:
measuring an amount of ore mined during the control-deactivated period; and
measuring an amount of ore mined during the control-activated period;
wherein the step of determining the control-deactivated and control-activated dust levels has regard to the respective measured amounts of ore mined.

3. A method as claimed in claim 1, wherein the control-activated period is terminated when a certain amount of ore has been mined since a commencement of the control-activated period, and the control-deactivated period is terminated when the same or similar certain amount of ore has been mined since a commencement of the control-deactivated period.

4. A method as claimed in claim 1, wherein the control-activated period covers a certain fraction or number of mining cycles, and the control-deactivated period covers the same certain fraction or number of mining cycles.

5. A method as claimed in claim 4, further comprising the steps of:
measuring an amount of ore produced during the control-activated period; and
measuring an amount of ore produced during the control-deactivated period;
wherein the step of determining the control-activated and control-deactivated dust levels has regard to the respective amounts of ore produced.

6. A method as claimed in claim 4, wherein the determined dust levels are equivalent to or functions of the amounts of dust measured per the amounts of ore mined in the respective periods.

7. A method as claimed in claim 2, wherein the determined dust levels are equivalent to or functions of the amounts of dust measured per the amounts of ore mined in the respective periods.

8. A method as claimed in claim 1, wherein the step of comparing comprises computing and reporting a dust control efficiency as an absolute or percentage amount by which the control-activated dust level was changed compared to control-deactivated dust level.

9. A method as claimed in claim 1, wherein the mine is a coal mine and the ore is coal.

10. A method as claimed in claim 9, wherein the dust is respirable or inhalable dust.

11. A method as claimed in claim 9, wherein the coal mine is an underground longwall coal mine.

12. A method as claimed in claim 1, wherein the control-activated and control-deactivated periods are substantially shorter that an entire shift.
